(19) United States
(12) Patent Application Publication
(10) Pub. No.: US 2012/0154382 A1
(43) Pub. Date: Jun. 21, 2012

(54) IMAGE PROCESSING APPARATUS AND IMAGE PROCESSING METHOD

(75) Inventors: Nobuyuki IKEDA, Fuchu-shi (JP); Tatsuya MIYAKE, Kawasaki-shi (JP); Tatsuhiro NISHIOKA, Kawasaki-shi (JP)

(73) Assignee: KABUSHIKI KAISHA TOSHIBA, Tokyo (JP)

(21) Appl. No.: 13/271,920

(22) Filed: Oct. 12, 2011

(30) Foreign Application Priority Data
Dec. 21, 2010 (JP) 2010-284752

(51) Int. Cl. G06T 15/00

(52) U.S. Cl. 345/419

(57) ABSTRACT

According to one embodiment, an image processing apparatus includes a generation module and a controller. The generation module is configured to generate 3D image data. The controller is configured to control a depth range in a depth direction of a display range, within which the 3D image data is fallen, and a starting position of the depth range.

### CROSS-REFERENCE TO RELATED APPLICATIONS

This application is based upon and claims the benefit of priority from prior Japanese Patent Application No. 2010-284752, filed Dec. 21, 2010, the entire contents of which are incorporated herein by reference.

### FIELD

Embodiments described herein relate generally to an apparatus and a method which perform image processing.

### BACKGROUND

Three-dimensional image display techniques of various methods have been developed at present. An example of the techniques is a three-dimensional image display technique using spectacles. The user can cognize a three-dimensional image, by viewing a right-eye image and a left-eye image which are displayed on an image display apparatus with special spectacles.

Another example of the techniques is a technique of a naked-eye type. The user can cognize a three-dimensional image, by viewing a plurality of parallactic images, which are obtained at viewpoints shifted in the left and right directions and displayed on an image display apparatus, without using special spectacles. Generally, three-dimensional image display techniques of the naked eye type adopt a both-eyes parallax method using parallax between both eyes.

A three-dimensional image is formed of a three-dimensional image based on 3D image data obtained by processing content obtained from broadcasting waves. When the depth in the depth direction of the display range of 3D image data and the starting position in the depth direction of the display range of the 3D image data vary, the viewability and the presece which the user cognizes vary, even for the same 3D image data.

For example, when 3D image data includes data such as characters, figures, and symbols, there are cases where the user feels that the characters or the like are difficult to view. This is because display apparatuses sometimes generate minute crosstalk, when they display projection and depression of 3D image data such that the user cognizes a three-dimensional image. Even when crosstalk is generated, when the 3D image data does not include characters but is only formed of images such as people and landscapes, the user does not feel that the three-dimensional image is difficult to view. However, when the 3D image data includes characters and the like, the user feels that the three-dimensional image is difficult to view when crosstalk occurs. Therefore, it is necessary to adaptively control the depth in the depth direction and the starting position of the display range of 3D image data, in accordance with the contents of the 3D image data.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary schematic diagram of a three-dimensional image display apparatus according to a first embodiment.

FIG. 2 is an exemplary diagram illustrating an example of a whole structure of a television receiving apparatus which is united with the three-dimensional image display apparatus according to the first embodiment.

FIG. 3 is an exemplary schematic diagram illustrating a maximum display range of a three-dimensional image which is displayed by the three-dimensional image display apparatus according to the first embodiment.

FIG. 4 is an exemplary schematic diagram illustrating how a three-dimensional image displayed by the three-dimensional image display apparatus according to the first embodiment is viewed.

FIG. 5 is an exemplary block diagram illustrating a structure of a 3D processor according to the first embodiment.

FIG. 6 is an exemplary diagram illustrating reduction of a display range according to the first embodiment.

FIG. 7 is an exemplary block diagram illustrating a structure of a 3D processor according to a second embodiment.

FIG. 8 is an exemplary diagram illustrating a control table according to the second embodiment.

### DETAILED DESCRIPTION

Various embodiments will be described hereinafter with reference to the accompanying drawings.

In general, according to one embodiment, an image processing apparatus includes a generation module and a controller. The generation module is configured to generate 3D image data. The controller is configured to control a depth range in a depth direction of a display range, within which the 3D image data is fallen, and a starting position of the depth range.

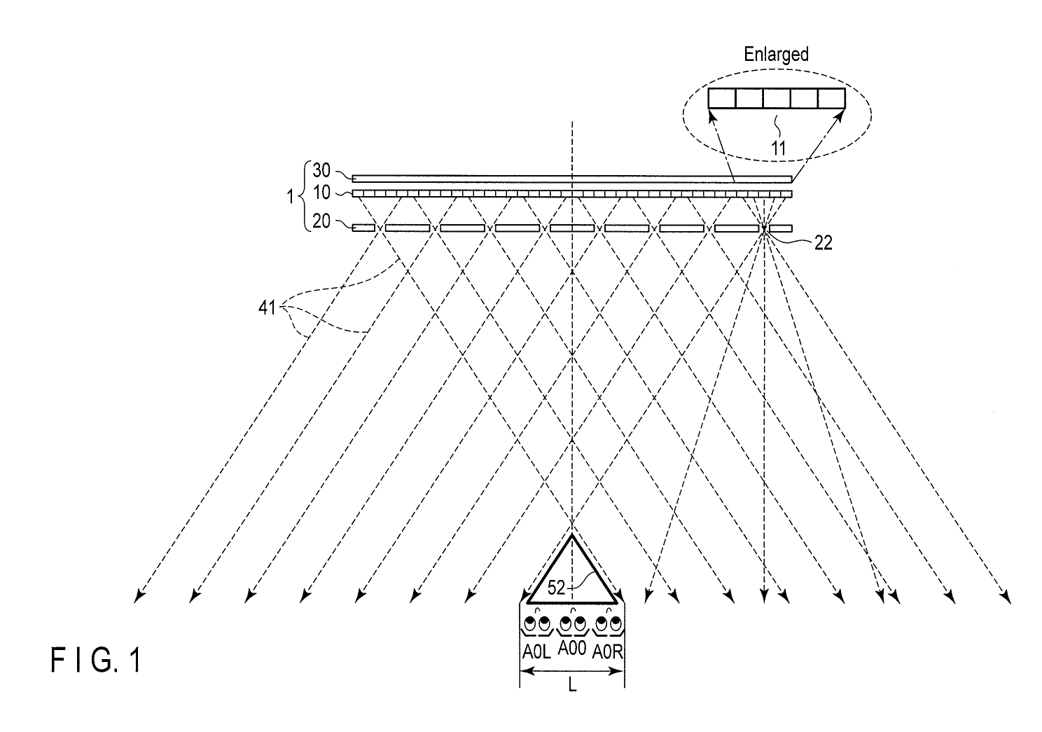

Embodiments will be described hereinafter with reference to drawings. First, the principle of three-dimensional display will be explained hereinafter. FIG. 1 is a cross-sectional view which schematically illustrates an example of an image display apparatus according to a first embodiment. Although the first embodiment shows an example of a three-dimensional image display technique of an integral method, the method of three-dimensional display may be the naked-eye method or the spectacle method other than the integral method.

A three-dimensional image display apparatus 1 illustrated in FIG. 1 comprises a display unit 10 which has a number of three-dimensional image display pixels 11 that are arranged in rows and columns, and a mask 20 which is provided with a number of window parts 22 that are positioned apart from the pixels 11 and correspond to the pixels 11.

The mask 20 includes optical openings, and has a function of controlling light beams from the pixels. The mask 20 is also referred to as a parallactic barrier or light-beam controlling element. As the mask 20, it is possible to use a structure in which a light-shield pattern which includes a number of openings corresponding to a number of window parts 22 is formed on a transparent board, or a light-shield board provided with a number of through holes corresponding to a number of window parts 22. As another example of the mask 20, it is possible to use a fly-eye lens which is formed by arranging a number of minute lenses in a two-dimensional manner, or a lenticular lens which includes optical openings that extend in a straight line in a vertical direction and are periodically arranged in a horizontal direction. In addition, as the mask 20, it is possible to use a structure in which the arrangement, size, and/or shape of the window parts 22 can be changed, such as a transmission liquid crystal display unit.

To view a moving image as a three-dimensional image, three-dimensional display pixels 11 are realized by using a liquid crystal display unit. A number of pixels of the transmission liquid crystal display unit 10 form a number of three-dimensional display pixels 10, and a backlight 30 which is a surface light source is arranged on the back side of the liquid crystal display unit 10. The mask 20 is arranged on the front side of the liquid crystal display unit 10.

In the case of using the liquid crystal display unit 10 of a transmission type, the mask 20 may be disposed between the backlight 30 and the liquid crystal display unit 10. Instead of the liquid crystal display unit 10 and the backlight 30, it is possible to use a self-light-emitting display apparatus, such as an organic EL (electroluminescence) display apparatus and a plasma display apparatus. In such a case, the mask 20 is disposed on the front side of the self-light-emitting display apparatus.

FIG. 1 schematically illustrates relation between the three-dimensional display apparatus 1 and observing positions A00, A0R, and A0L. The observing positions are positions obtained by moving in parallel with the horizontal direction of the display screen, with the distance from the screen (or the mask) fixed. This example shows a case one three-dimensional image display pixel 11 is formed of a plurality of (for example, five) two-dimensional display pixels. The number of pixels is an example, and may be smaller (for example, two) or larger (for example, nine) than five.

In FIG. 1, broken lines 41 are straight lines (light beams) each of which connects the pixel center located in the boundary between adjacent three-dimensional display pixels 11 with a window part 22 of the mask 20. In FIG. 1, an area enclosed by bold lines 52 is an area in which a true three-dimensional image (original three-dimensional image) is cognized. The observing positions A00, A0R, and A0L fall within the area of the bold lines 52. The observing position in which only a true three-dimensional image is observed is referred to as “viewing area”.

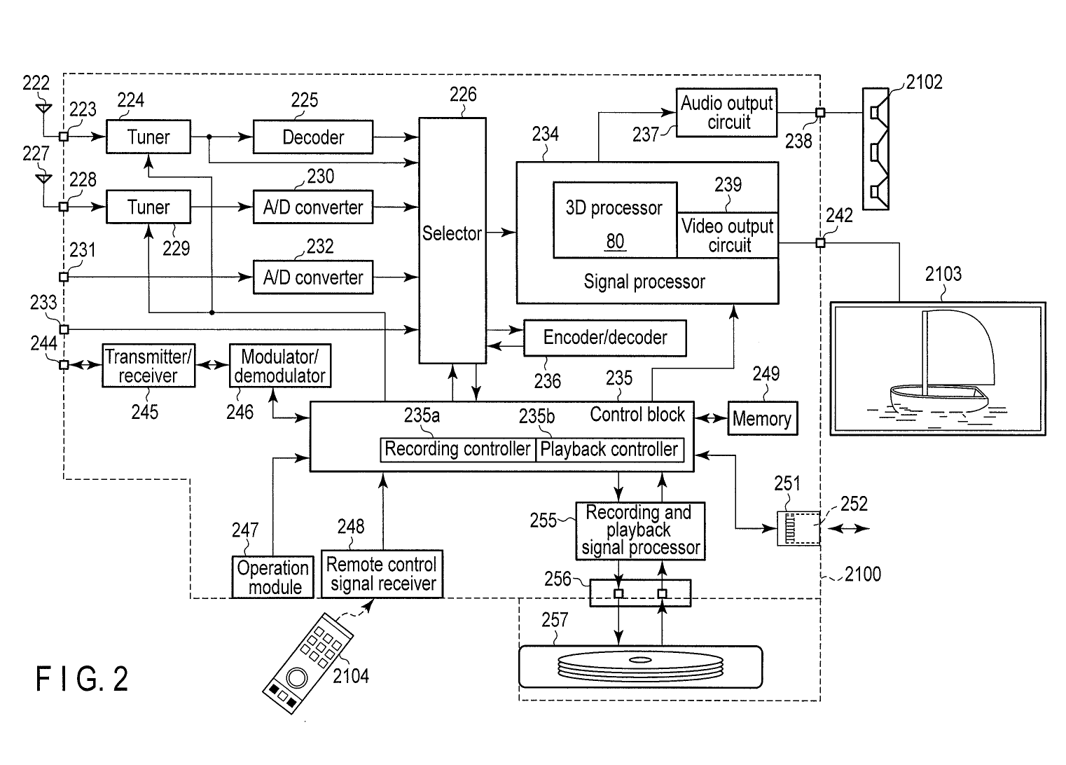

FIG. 2 schematically illustrates a signal processing system of a television broadcasting apparatus 2100, which is an example of an apparatus to which the three-dimensional display apparatus 1 is applied. A digital television broadcasting signal which is received by a digital television broadcasting receiving antenna 222 is supplied to a tuner 224 through an input terminal 223. The tuner 224 selects and demodulates a signal of a desired channel from the input digital television broadcasting signal. A signal outputted from the tuner 224 is supplied to a decoder 225, subjected to MPEG (moving picture experts group)-2 decoding, and then supplied to a selector 226.

In addition, the output of the tuner 224 is directly supplied to the selector 226. Image and sound data is separated from the signal. The image and sound data is processed by a recording and playback signal processor 255 through a controller 235, and can be recorded on a hard disk drive (HDD) 257. The HDD 257 is connected as a unit to the recording and playback processor 255 through a terminal 256, and can be exchanged for another HDD. The HDD 257 includes a signal recorder and a signal reader.

An analog television broadcasting signal which is received by an analog television broadcasting receiving antenna 227 is supplied to a tuner 229 through an input terminal 228. The tuner 229 selects and demodulates a signal of a desired channel from the input analog television broadcasting signal. A signal outputted from the tuner 229 is digitized by an A/D (analog/digital) converter 230, and thereafter outputted to the selector 226.

In addition, an analog image and sound signal which is supplied to an analog signal input terminal 231, to which an apparatus such as a VTR is connected, is supplied to an A/D converter 232 and digitized, and thereafter outputted to the selector 226. A digital image and sound signal which is supplied to a digital signal input terminal 233, to which an external apparatus such as an optical disk and a magnetic recording medium playback apparatus is connected through an HDMI (High Definition Multimedia Interface) 261 or the like, is directly supplied to the selector 226.

When the A/D converted signal is recorded on the HDD 257, the signal is subjected to compression by a predetermined format, such as MPEG (moving picture experts group)-2, by an encoder in an encoder/decoder 236 which accompanies the selector 226, and thereafter recorded on the HDD 257 through the recording and playback signal processor 255. When the recording and playback signal processor 255 records information on the HDD 257 by cooperating with a recording controller 235a, recording and playback signal processor 255 is programmed in advance to determine what information is recorded on which directory of the HDD 257. Therefore, conditions for storing a stream file in a stream directory, and conditions for storing identification information in a recording list file are set in the recording and playback signal processor 255.

The selector 226 selects one signal from the four input digital image and sound signals, and supplies the selected signal to a signal processor 234. The signal processor 234 separates image data and sound data from the input digital image and sound signal, and subjects the data to predetermined signal processing. As signal processing, the sound data is subjected to audio decoding, sound quality control, and mixing as desired. The image data is subjected to color and brightness separation, color control, and image quality control and the like.

The signal processor 234 superposes graphics data on image data, if necessary. The signal processor 234 also includes a 3D processor 80. The 3D processor 80 generates a three-dimensional image. The structure of the 3D processor 80 will be described later. A video output circuit 239 controls to display a plurality of parallactic images based on the image data on a display apparatus 2103. The video output circuit 239 functions as display controller for parallactic images.

The image data is outputted to the display apparatus 2103 through an output terminal 242. As the display apparatus 2103, for example, the apparatus explained in FIG. 1 is adopted. The display apparatus 2103 can display both plane images (2D) and three-dimensional images (3D). Although a three-dimensional image is cognized by the user by viewing a plurality of parallactic images displayed on the display apparatus 2103, the first embodiment is explained on the assumption that the 3D processor 80 generates a pseudo-three-dimensional image with a depth, and the display apparatus 2103 displays a pseudo-three-dimensional image with a depth.

The sound data is converted to analog data by an audio output circuit 237, subjected to volume control and channel balance control and the like, and outputted to a speaker device 2102 through an output terminal 238.

Various operations including various receiving operations of the television broadcasting receiving apparatus 2100 are controlled by a control block 235. The control block 235 is an assembly of microprocessors including a CPU (central processing unit) and the like. The control block 235 obtains operation information from an operation module 247 or operation information transmitted from a remote controller 2104 through a remote control signal receiver 248, and controls blocks in the apparatus to reflect the operation contents.

The control block 235 uses a memory 249. The memory 249 mainly includes a ROM (read only memory) which stores a control program executed by the CPU, a RAM (random access memory) to provide the CPU with a work area, and a nonvolatile memory which stores various setting information items and control information.

The apparatus can communicate with an external server through the Internet. A downstream signal from a connecting terminal 244 is demodulated by a transmitter/receiver 245, demodulated by a modulator/demodulator 246, and inputted to the control block 235. An upstream signal is modulated by the modulator/demodulator 246, converted into a transmission signal by the transmitter/receiver 245, and outputted to the connecting terminal 244.

The control block 235 can convert moving images or service information downloaded from an external server, and supply it to the signal processor 234. The control block 235 can also transmit a service request signal to an external server, in response to operation of the remote controller.

The control block 235 can also read data of a card type memory 252 attached to a connector 251. Therefore, the apparatus can take photograph image data or the like from the card type memory 252, and display the data on the display apparatus 2103. In addition, when special color control or the like is performed, the control block 235 can use image data from the card type memory 252 as standard data or reference data.

In the above apparatus, when the user wishes to view a desired program of a digital television broadcasting signal, the user controls the tuner 224 and selects the program, by operating the remote controller 2104.

The output of the tuner 224 is decoded by the decoder 225 and demodulated into a baseband image signal. The baseband image signal is inputted from the selector 226 to the signal processor 234. Thereby, the user can view the desired program on the display apparatus 2103.

When the user wishes to play back and view a stream file which is recorded on the HDD 257, the user designates display of a recording list file by operating, for example, the remote controller 2104. When the user designates display of the recording list file, a recording list is displayed as a menu. Therefore, the user moves the cursor to a position of a desired program name or a file name in the displayed list, and operates the select button. Thereby, playback of the desired stream file is started.

The designated stream file is read out from the HDD 257 under the control of the playback controller 235b, decoded by the recording and playback signal processor 255, and inputted to the signal processor 234 through the control block 235 and the selector 226.

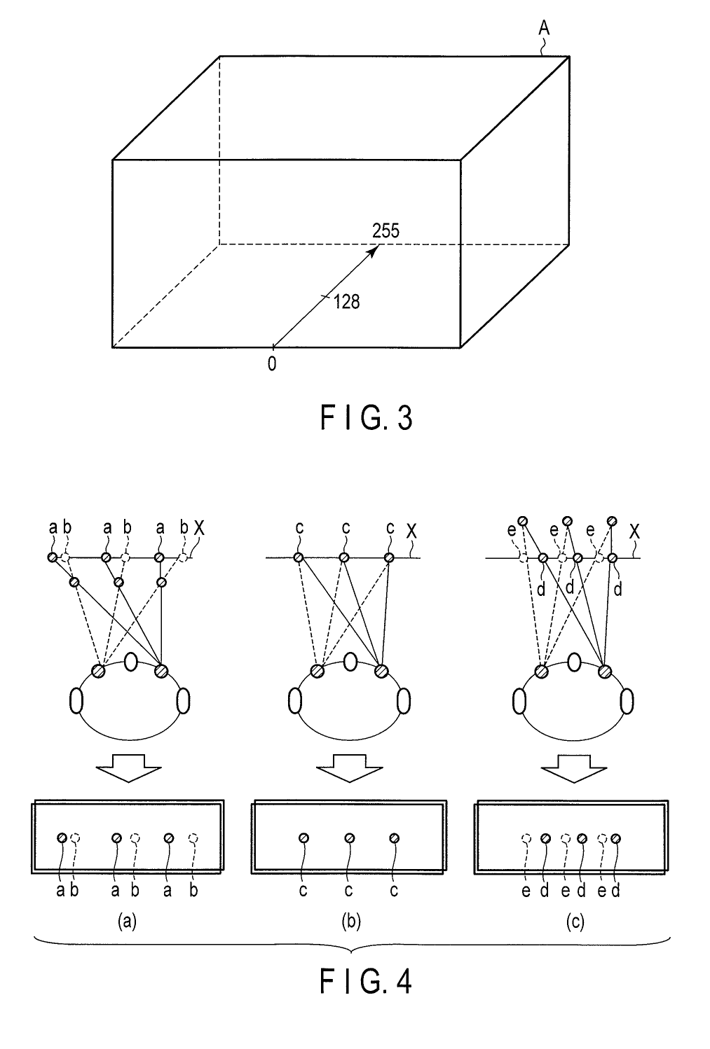

FIG. 3 is a schematic diagram illustrating a maximum display range A of a three-dimensional image, which the display apparatus 2103 can display. The maximum display range A indicates a full range which is the maximum size in the depth direction of the three-dimensional image. Although the maximum display range A varies according to the performance of the display apparatus 2103, the maximum display range A is applicable to the case where the user in the viewing area views the display apparatus 2103. In the first embodiment, the term “depth” is defined as a position from the front toward the depth direction in the maximum display range A in the depth direction of a three-dimensional image. The relative value of the front of the maximum display range A is defined as 0, and the relative value of the deepest end of the maximum display range A is defined as 255. Therefore, the depth range of the maximum display range A is the full range, that is, 255. In the first embodiment, the size (depth) in the depth direction of a three-dimensional image is defined as depth range. Although the value of the front of the maximum display range A is defined as 0, the value of the deepest end of the maximum display range A may be defined as 0. As another example, the value of the center in the maximum display range A may be defined as 0, the value of the front may be defined as 127, and the value of the deepest end may be defined as −128.

In addition, in the first embodiment, a plane in the depth direction, on which the finest image is projected when the user in the viewing area views a plane image (2D) displayed on the display apparatus 2103, is defined as a projection plane. Generally, the projection plane is a panel surface of the display apparatus 2103. In the first embodiment, suppose that the panel surface of the display apparatus 2103 is the projection plane, and the depth of the projection plane in the depth direction is 128, which is the center of the maximum display range.

FIG. 4 is a schematic drawing illustrating how a three-dimensional image displayed by the display apparatus 2103 is viewed. FIG. 4(a) illustrates a panel surface X on which a plurality of pixels a that form a right-eye parallactic image and a plurality of pixels b that form a left-eye parallactic image are arranged. When the user in the viewing area views the display apparatus 2103, the user cognizes the pixels a with the right eye and forms a parallactic image, and cognizes the pixels b with the left eye and forms a parallactic image, as illustrated in the lower diagram of FIG. 4(a). As illustrated in the upper diagram of FIG. 4(a), the user cognizes an image which projects forward from the panel surface X, by parallax between the right eye and the left eye.

FIG. 4(b) illustrates a panel surface X of the display apparatus 2103, on which a plurality of pixels c which form a right-eye and a left-eye parallax images are arranged. When the user in the viewing area views the display apparatus 2103, the user generates a parallax image by cognizing the pixels c with the right eye, and generates a parallax image by cognizing the pixels c with the left eye, as illustrated in the lower diagram of FIG. 4(b). The user cognizes a image (2D) which is projected on the panel surface X by parallax between the right eye and the left eye, as illustrated in the upper diagram of FIG. 4(b). Specifically, in this case, the image is projected on the same position as the panel surface X which is the projection plane, regardless of parallax between the left and the right eyes.

FIG. 4(c) illustrates a panel surface X of the display apparatus 2103, on which a plurality of pixels d which form a right-eye parallactic image and a plurality of pixels e which form a left-eye parallactic image are arranged. When the user in the viewing area views the display apparatus 2103, the user generates a parallactic image by cognizing the pixels d with the right eye, and generates a parallactic image by cognizing the pixels e with the left eye, as illustrated in the lower diagram of FIG. 4(c). As illustrated in the upper diagram of FIG. 4(c), the user cognizes an image which recedes from the panel surface X by parallax between the right and left eyes.

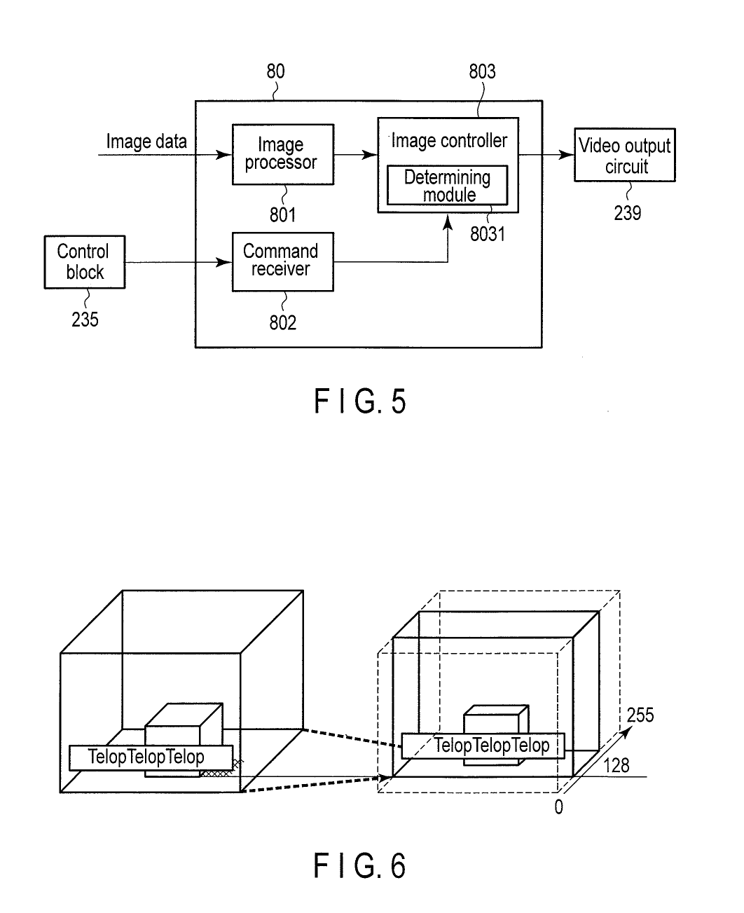

Next, the structure of the 3D processor 80 is explained. FIG. 5 illustrates a structure of the 3D processor 80. The 3D processor 80 includes an image processor 801, a command receiver 802, and an image controller 803.

The image processor 801 obtains 2D image data. The 2D image data is obtained by signal processing of an image signal by the signal processor 234. The image signal may be included in a broadcasting signal obtained by the tuner 224, supplied from an external apparatus through the HDMI 1261, or based on content stored in the HDD 257, and not limited. The image processor 801 generates 3D image data from the 2D image data. The image processor 801 functions as generation module for 3D image data. Any technique can be adopted as a technique of converting 2D image data into 3D image data. The image processor 801 does not need 3D image data generating processing when the input image data is 3D image data. The image processor 801 supplies the 3D image data to the image controller 803.

The command receiver 802 receives a control command. A control command is a command to change (reduce) 3D image data to fall within a display range, not the maximum display range. The display range is defined with the front depth of 128, which is the depth of the projection plane, and the depth range of 127 at the maximum that extends from 128 to 255. Specifically, the control command is a command to control the starting position of the depth range and the depth range of the display range, within which the 3D image data is fallen. The command receiver 802 receives, for example, a control command which is inputted by the user with the remote controller 2104, or a control command from an external apparatus through the HDMI 261. When the image signal includes a control command, the command receiver 802 may obtain the control command from the image signal. The command receiver 802 outputs the control command to the image controller 803.

The image controller 803 includes a determining module 8031. The determining module 8031 determines whether a control command is received from the command receiver 802 or not. The following is explanation of the case where the command receiver 802 does not receive any control commands. The image controller 803 processes 3D image data such that the 3D image data falls within a display range. The display range in this case is the maximum display range, which is defined with the starting position of the depth range of 0 and the depth range of 255.

Next, the following is explanation of the case where the command receiver 802 receives a control command. The image controller 803 processes 3D image data such that the 3D image data falls within a display range. The display range in this case is a range that is defined with the starting position of the depth range of 128, which is the depth of the projection plane, and the depth range of, for example, 10. Specifically, the image controller 803 reduces the display range, which the 3D image data is fallen within, from the maximum display range. In this explanation, the reduced display range is referred to as “reduced display range”. The image controller 803 stores data which relates to the reduced display range and in which the starting position of the depth range and the depth range are determined in advance. FIG. 6 illustrates an example in which the display range having the full range is reduced to a reduced display range having a depth range that is smaller (narrower) than the full range. The left diagram of FIG. 6 illustrates a state where the image controller 803 makes 3D image data fall within the display range having the full range. The right diagram of FIG. 6 illustrates a state where the image controller 803 makes 3D image data fall within a display range which has a starting position of the depth range of 128 that is the depth of the projection plane, and a depth range that is smaller than the full range.

The image controller 803 generates a plurality of parallactic images from the 3D image data which is fallen within the display range. The image controller 803 supplies the parallactic images to the video output circuit 239. The video output circuit 239 controls to display the parallactic images on the display apparatus 2103. The display apparatus 2103 displays a three-dimensional image by using the parallactic images. The display apparatus 2103 displays such that the user can view a three-dimensional image with a depth, when the user in the viewing area views the display apparatus 2103.

As explained above, the image controller 803 controls such that the depth range starting position of the reduced display range is brought close to the depth of the projection plane. Generally, the depth of character data included in 3D image data is the depth of the front end of the display range. In the first embodiment, the term “characters” indicates telops that include characters, symbols, and figures, graphics, and characters written on large charts held by anchors. Therefore, when the user recognizes that the 3D image data displayed on the display apparatus 2103 corresponds to content which includes character data (such as news), the user can input a control command by the remote controller 2104. Thereby, the user can cognize character data projected on the projection plane in a less-blurred and clear state.

Although the depth range of the reduced display range is explained as 10 as an example, the depth range is not specifically limited. The depth range of the reduced display range may be any range, as long as it has the depth of the projection plane as the starting position and does not exceed the depth of the deepest end of the maximum display range. The solidity which the user cognizes for the 3D image data displayed on the display apparatus 2103 is reduced, as the depth range of the reduced display range is narrowed. Therefore, the user can more clearly cognize character data projected on the projection plane. On the other hand, the depth range of the reduced display range may be set to the maximum, to extend from the depth of the projection plane as the starting position to the depth of the deepest end of the maximum display range. The solidity which the user cognizes for the 3D image data displayed on the display apparatus 2103 is increased, as the depth range of the reduced display range is widened. Therefore, the user can cognize a three-dimensional image with the maximum 3D effect, for data other than character data included in the 3D image data.

Although the image controller 803 stores data relating to the predetermined reduced display range, the data relating to the reduced display range may be variable. When the user inputs a setting of a depth range starting position and a depth range in the reduced display range by the remote controller 2104, the control block 235 transmits information relating to the setting to the image controller 803. The image controller 803 updates and stores the depth range starting position and the depth range in the reduced display range which are set by the user. The image controller 803 has a function of updating and storing the data relating to the reduced display range. Also, when the television broadcasting receiving apparatus 2100 is started next time, the image controller 803 applies the updated data relating to the reduced display range to 3D image data. The solidity of 3D image data displayed on the display apparatus 2103 and visibility of character data included in the 3D image data vary person to person. Therefore, the user can cognize 3D image data which is fallen within the reduced display range which is in an optimum state for the user.

As explained above, although the image controller 803 applies the data relating to the reduced display range to control the depth range starting position of the reduced display range to the depth of the projection plane, the first embodiment is not limited to it. For example, the image controller 803 analyzes 3D image data, and determines on what position from the front side of the display range character data is projected. For example, when the image processor 801 generates 3D image data from 2D image data, the image controller 803 determines it from the generating processing. For example, when the signal processor 234 obtains an image signal including 3D image data, the image controller 803 determines it based on information relating to the depth of the 3D image data included in the image signal.

The image controller 803 may control the reduced display range, such that the position of character data included in 3D image data is the depth of the projection plane and the depth range is narrower than the full range. When it cannot be determined on what position from the front side of the display range the character data is projected, the image controller 803 may control the reduced display range, such that the depth range is narrower than the full range and the center of the depth range is the depth of the projection plane.

According to the first embodiment, even when 3D image data includes character data, the display apparatus 2103 can display a three-dimensional image by which the user can clearly cognize character data without occurrence of cross talk.

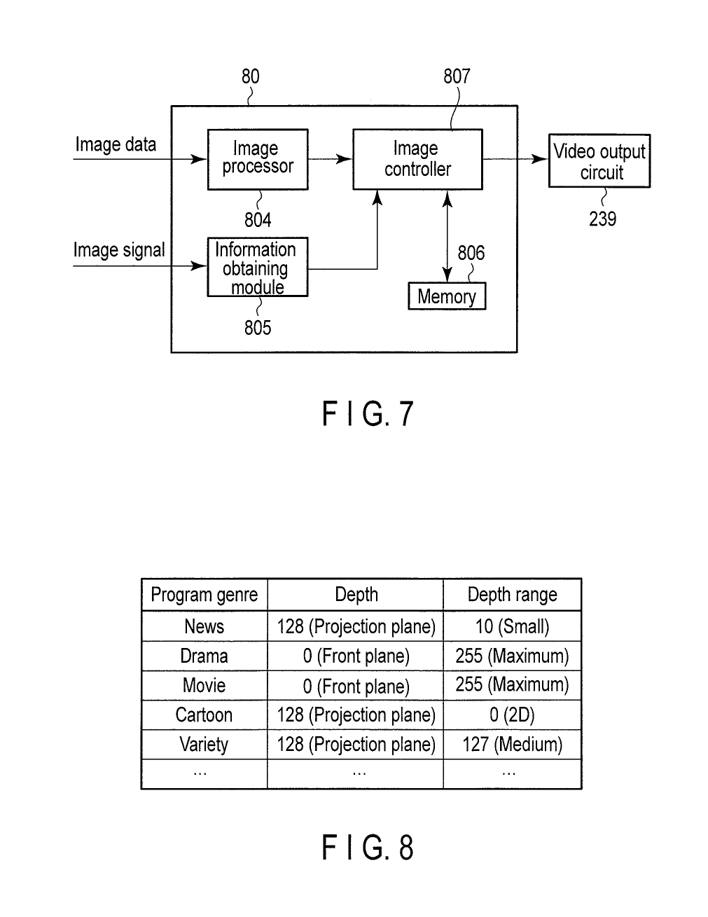

Next, a second embodiment will be explained hereinafter. FIG. 7 is a block diagram illustrating a structure of a 3D processor 80 according to the second embodiment. The second embodiment is the same as the first embodiment, except for the structure of the signal processor 80. The signal processor 80 includes an image processor 804, an information obtaining module 805, a memory 806, and an image controller 807.

The image processor 804 has the same structure as that of the image processor 801. The information obtaining module 805 obtains an image signal corresponding to image data that is inputted to the image processor 804. The image signal may be based on a broadcasting signal which is obtained by a tuner 224, supplied from an external apparatus through ah HDMI 261, or based on content recorded on an HDD 257, and not limited. The information obtaining module 805 obtains genre information of the image data from the image signal. The information obtaining module 805 supplies the genre information to the image controller 807.

The memory 806 stores a control table relating to the display range of 3D image data. The memory 806 functions as a module to store the control table. FIG. 8 illustrates an example of the control table. The control table stores the following settings according to the genre of the program of the 3D image data. When the genre is news, the depth range starting position of the display range is set to 128 which is the depth of the projection plane, and the depth range of the display range is set to 10. The news is a program in which a number of characters are used. Therefore, the depth range starting position is set such that character data is projected on a part around the projection plane. The depth range is set to a small value to reduce the solidity of the 3D image data in consideration of the visibility of the character data.

When the genre is drama or movie, depth range starting position of the display range is 0 which is the front of the maximum display range, and the depth range of the display range is set to 255, which is the full range. The drama and the movie are programs in which the user enjoys the solidity of 3D image data to the maximum. Therefore, the depth range is set to the full range (maximum).

When the genre is cartoon, the depth range starting position of the display range is set to 128, and the depth range is set to 0. The cartoon is a program in which 3D effect is low. Therefore, the depth range is set to 0 (that is, 2D).

When the genre is variety show, the depth range starting position of the display range is set to 128 which is the depth of the projection plane, and the depth range of the display range is set to 127. The variety show is a program in which a number of telops are used and the user also enjoys the background. Therefore, the depth range starting position is set such that character data is projected on a part around the projection plane. The depth range is set as wide as possible, although it is about half the full range. The genres of the control table illustrated in FIG. 7 are only an example. The depth range starting position and the depth range is set for each of other genres such as information program and sports.

The image controller 807 identifies the genre of the 3D image data based on the genre information. The image controller 807 obtains information relating to the depth range starting position and the depth range set for the identified genre, from the control table. The image controller 807 processes the 3D image data such that the 3D image data falls within the display range that is defined by the obtained depth range starting position and the depth range. For example, when the genre of the 3D image data is news, the image controller 807 controls the display range of the 3D image data from the maximum display range illustrated in the left diagram of FIG. 6 to the display range with the reduced depth range illustrated in the right diagram of FIG. 6.

The information relating to the depth range starting position and the depth range of each genre set in the control table may be variable. When the user inputs a setting of the depth range starting position and the depth range of a desired genre by a remote controller 2104, the control block 235 transmits information relating to the setting to the 3D processor 80. The 3D processor 80 reflects the depth range starting position and the depth range of the genre which are set by the user on the control table. The memory 806 updates and stores the control table. The image controller 807 applies the updated control table to the 3D image data, when a television broadcasting receiving apparatus 2100 is started next time. Therefore, the user can cognize 3D image data in an optimum state (visibility and solidity) for the user.

As explained above, although the image controller 807 controls the display range in accordance with the genre of the 3D image data, the second embodiment is not limited to it. The image controller 807 may control the display range according to whether the 3D image data includes character data or not. In this case, the image controller 807 determines whether the 3D image data includes character data or not. When the 3D image data includes character data, the image controller 807 applies, for example, the display range which is set for news as illustrated in FIG. 8 to the 3D image data. When the 3D image data does not include character data, the image controller 807 applies, for example, the display range which is set for drama as illustrated in FIG. 8 to the 3D image data.

In addition, the image controller 807 may control the display range in accordance with the receiving time zone of the broadcasting signal including 3D image data. When the image controller 807 determines that the 3D image data is based on a broadcasting signal, the image controller 807 obtains the current time (the time zone in which the broadcasting signal is received) from a timer (not shown) or information included in the broadcasting signal. When the time zone in which the broadcasting signal is received is morning, the image controller 807 applies a predetermined display range for the morning time zone to the 3D image data. In this case, the image controller 807 applies, for example, the display range which is set for drama in FIG. 8 to the 3D image data. This is because a number of dramas are broadcasted in the morning. When the time zone in which the broadcasting signal is received is the daytime, the image controller 807 applies a predetermined display range for the daytime time zone to the 3D image data. In this case, the image controller 807 applies, for example, the display range which is set for news in FIG. 8 to the 3D image data. This is because a number of news programs are broadcasted in the daytime.

According to the second embodiment, the image controller 807 can dynamically control an optimum display range according to the genre (contents) of the 3D image data, presence/absence of character data, and the receiving time zone of the broadcasting signal. This structure removes the trouble of controlling the display range each time from the user, and the convenience is improved.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a generation module configured to generate 3D image data; and
a controller configured to control a depth range and a starting position of the depth range, where the depth range is in a depth direction of a display range, the controller further configured to display the 3D image data such that the 3D image data is visible in the depth direction.

2. The apparatus of claim 1, wherein
the controller is configured to control the starting position such that the starting position is located in a projection plane if the 3D image data includes character data.

3. The apparatus of claim 2, wherein
the controller is configured to narrow the depth range when the 3D image data includes the character data.

4. The apparatus of claim 2, further comprising:
a determination module configured to determine whether there is a command to control the starting position.

5. The apparatus of claim 1, wherein
the controller is configured to control the depth range and the starting position based on contents of the 3D image data.

6. The apparatus of claim 1, wherein
the controller is configured to control the depth range and the starting position based on whether the 3D image data includes character data.

7. The apparatus of claim 1, wherein
the controller is configured to control the depth range and the starting position based on a time zone in which a broadcast signal is received, the broadcast signal comprising the 3D image data.

8. The apparatus of claim 1, further comprising:
a memory configured to update and store a setting of the depth range and the starting position based on an input.

9. An image processing method comprising:
generating 3D image data; and
controlling a depth range and a starting position of the depth range, the depth range in a depth direction of a display range, the controller further configured to display the 3D image data such that the 3D image data is visible in the depth direction.
